(19) United States
(12) Patent Application Publication
(10) Pub. No.: US 2008/0246276 A1
(43) Pub. Date: Oct. 9, 2008

(54) Sump Wall Penetration Fitting

(76) Inventors: Sergio M. Bravo, Commerce, CA (US); Don K. Mukai, Pasadena, CA (US)

Correspondence Address: CHRISTIE, PARKER & HALE, LLP, PO BOX 7068, PASADENA, CA, 91109-7068, US

(21) Appl. No.: 11/752,176

(22) Filed: May 22, 2007

Related U.S. Application Data
(60) Provisional application No. 60/747,904, filed on May 22, 2006.

(51) Int. Cl. F16L 3/04

(52) U.S. Cl. 285/139.2

(57) ABSTRACT

A penetration fitting is provided for forming a sealed penetration through an aperture of a sump wall. The penetration fitting includes a flanged coupling comprising a generally rigid coupler and an integral first flange extending around a portion of the coupler. The first flange is adapted to abut and be sealed against a first side of the sump wall around the aperture. The ends of the coupler further define first and second fittings, the second fitting adapted to extend through the aperture. A ring flange is provided that is adapted to be adhered to an outer circumferential portion of the coupler and to abut and be adhered to a second side of the sump wall around the aperture. Once sealed to the sump wall, the associated piping connections can be made.

### CROSS-REFERENCE TO RELATED APPLICATION(S)

This application claims the benefit of U.S. Provisional Application No. 60/747,904 filed on May 22, 2006, the entire disclosure of which is incorporated by reference.

### FIELD OF THE INVENTION

This invention relates to a penetration fitting which permits a conduit to pass through a wall of a sump, and especially, a sump used in an underground fuel storage system such as are commonly found at service stations.

### BACKGROUND

Secondary containment systems have been developed for gasoline service stations in order to prevent leaking hydrocarbons from contaminating the ground around and beneath such service stations. A secondary containment system typically includes a primary pipeline in which a product such as gasoline flows from an underground storage tank to a product dispenser, and a secondary pipeline that surrounds the primary pipeline. The purpose of the secondary pipeline is to contain any fluid that may leak from a damaged primary pipeline, and prevent the fluid from contaminating the surrounding ground. The secondary pipeline is generally monitored for fluid collection so that any leak in the primary pipeline can be repaired promptly.

A typical secondary containment system also includes one or more containment boxes or sumps beneath equipment such as gasoline or diesel product dispensers. Product pipelines extend through the walls of such sumps to pipe fittings which connect the primary pipelines to the product dispensers. Such sumps are designed to contain any product which may leak from faulty fittings or pipelines. In some installations, the secondary pipelines end at the walls of such sumps. In other installations, the secondary pipelines continue through the walls of such sumps such that virtually the entire piping system up to the product dispenser includes double-walled pipe. Furthermore, in some installations, the sumps are of a double-wall construction such that the inner wall acts as a portion of the secondary containment system while the outer wall acts as a tertiary containment system. Such installations are well known and are described in patents such as U.S. Pat. No. 6,823,886 which is incorporated by reference.

Regardless of the piping configuration, penetration fittings are used to form seals between sumps and the associated pipelines to contain leakage within the sumps. However, penetration fittings can be a source of system failure. Flexible penetration fittings tend to be made of materials that cannot withstand years of exposure to damp ground on one side, and hydrocarbons on the other side. Rigid penetration fittings tend to be complicated to install in that they require numerous glued joints. Furthermore, when using rigid penetration fittings, the entire system must generally be installed in its entirety, with final connection of both primary and secondary pipelines, before the integrity of such a system can be tested. If a fault is found after installation, large portions of the system, and in some cases, virtually the entire system must be dismantled in order to locate and correct the fault.

### SUMMARY OF THE INVENTION

A penetration fitting is provided for forming a sealed penetration through an aperture of a sump wall. The penetration fitting includes a flanged coupling comprising a generally rigid coupler and an integral first flange extending around a portion of the coupler. The first flange abuts a first side of the sump wall around the aperture. Opposing ends of the coupler further define first and second fittings, the second fitting adapted to extend through the aperture. A ring flange is provided that is adapted to be adhered to an outer circumferential portion of the coupler and abut a second side of the sump wall around the aperture.

In one embodiment, the first fitting is a tapered fitting for mating with a tapered secondary pipeline and the second fitting is a slip fitting for mating with a primary pipeline coaxially located within the secondary pipeline. Together, the primary and secondary pipelines define an annular space between the primary and secondary pipelines. For such an embodiment, the penetration fitting may include an optional secondary test port for external communication with the annular space and permitting the testing of the integrity of the secondary pipe system once installation is complete.

In still another embodiment, the coupler includes slip fittings on either end. For penetration fittings that include a slip fitting, the slip fitting may further include an interior adhesive channel and an adhesive injection port through which adhesive can be injected to adhere the slip fitting to the corresponding pipeline. In one embodiment, both the first and second slip fittings are adapted to mate with a secondary pipeline. In another embodiment, the first slip fitting is adapted to mate with a secondary pipeline and the second slip fitting is adapted to mate with a primary pipeline coaxially located within the secondary pipeline and defining an annular space as described above. For such an embodiment, the penetration fitting can further include an optional secondary test port for external communication with the annular space between the primary and secondary pipelines.

In another embodiment, the penetration fitting is designed for use with a double-wall sump that defines a sump wall interstice. For such an embodiment, at least one of the first and second fittings receives a secondary pipeline, and at least one interstitial port is provided for communication between the sump wall interstice and an outer wall of the secondary pipeline. This is useful for ensuring a proper seal between the penetration fitting and the double-wall sump wall. An optional interstice test port may be provided for external communication with the at least one interstitial port. This is useful for testing the integrity of the seal between the penetration fitting and the double-wall sump wall.

In still other another embodiment, each of the first and second fittings defines a bell-shaped opening. This embodiment is useful for sealing a curved conduit such as an electrical conduit to a sump wall.

### BRIEF DESCRIPTION OF THE DRAWINGS

FIG. 1A is an exploded sectional elevation view of a penetration fitting according to an embodiment of the invention;

FIG. 1B is a sectional elevation view of the penetration fitting of FIG. 1A assembled and including an assembly clamp;

FIG. 1C is a sectional elevation view of the penetration fitting of FIG. 1A assembled and with piping attached;

FIG. 2 is a sectional elevation view of an assembled penetration fitting according to another embodiment of the invention;

FIG. 3 is a sectional elevation view of an assembled penetration fitting according to yet another embodiment of the invention;

FIG. 4A is an exploded sectional elevation view of a penetration fitting according to still another embodiment of the invention;

FIG. 4B is an enlarged sectional elevation view of a portion of the penetration fitting of FIG. 4A assembled in a dry-fit state;

FIG. 5 is a sectional elevation view of an assembled penetration fitting according to still another embodiment of the invention;

FIG. 6A is an exploded sectional elevation view of a penetration fitting according to still another embodiment of the invention;

FIG. 6B is a sectional elevation view of the penetration fitting of FIG. 6A assembled; and

FIG. 7-11 are sectional elevation views of assembled penetration fittings according to still other embodiments of the invention.

### DETAILED DESCRIPTION

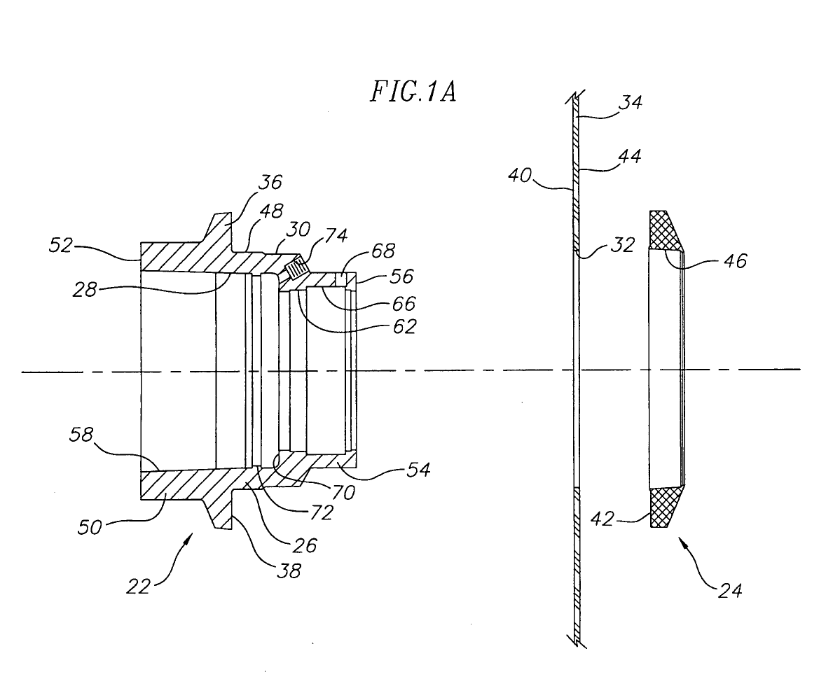

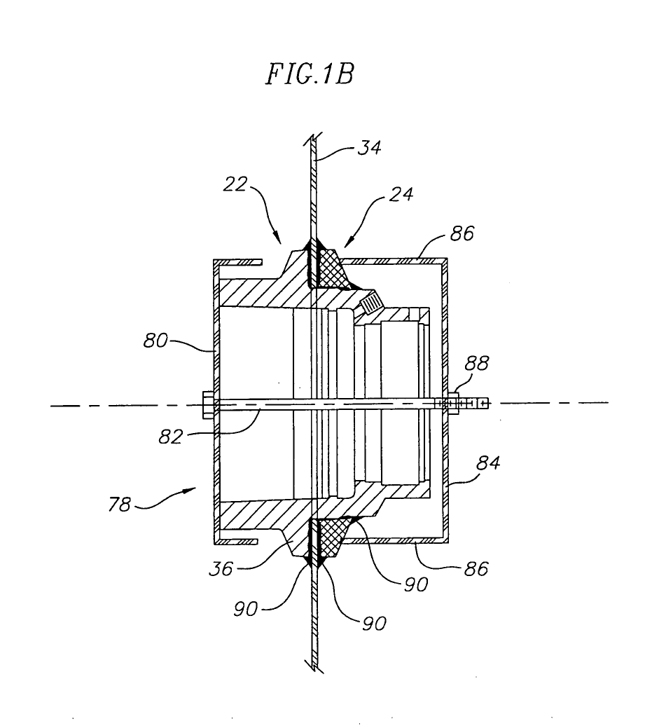

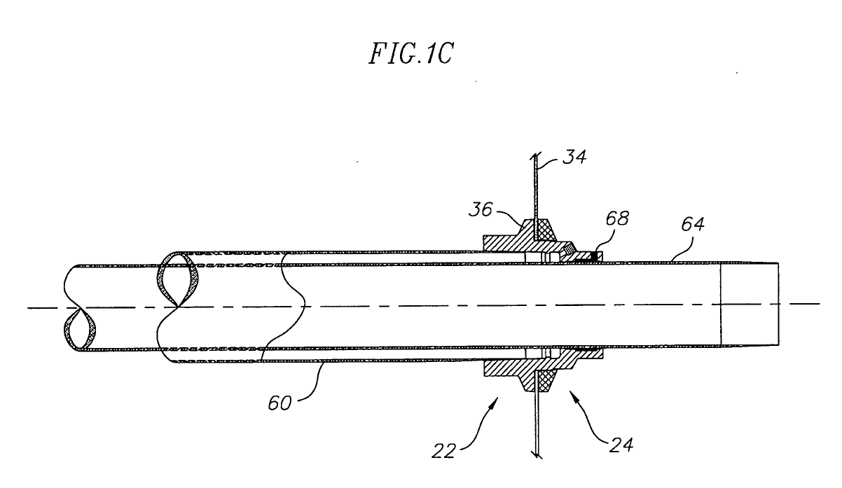

Referring to FIGS. 1A-1C, a generally rigid fiberglass penetration fitting according to an embodiment of the invention is illustrated, respectively, in a disassembled state, in an assembled state, and in an assembled state with the corresponding pipe connections glued in place. The penetration fitting includes a flanged coupling 22 and a mating flange ring 24. The flanged coupling includes a generally tubular coupler 26 defining inner 28 and outer 30 surfaces. The tubular coupler extends through an aperture 32 of a sump wall 34 and also includes an integral flange 36 located approximately midway along the length of the coupler and extending out from the outer surface of the coupler. The integral flange includes a first flange face 38 that is generally perpendicular to an outer wall 40 of the sump. The flange ring similarly includes a second flange face 42 parallel to an inner wall 44 of the sump and generally facing the first flange face. The flange ring further includes an inner bonding surface 46 for mating with an outer bonding surface 48 on the outer surface of the flanged coupling and adjacent the first flange face of the flanged coupling.

According to this embodiment, the coupler is a reducing coupler with a tapered pipe fitting 50 at a first end 52 and a slip fitting 54 at a second end 56. It should be noted that the term “slip fitting” as used in this specification is intended to refer to a fitting through which a conduit may extend, and of a configuration such that the conduit may be slid within the fitting to a desired orientation between the fitting and the conduit. Once the desired orientation is achieved, the fitting can then be sealed to the conduit. Such “slip fittings” may be distinguished from “socket fittings” which are fittings at which a length of pipe ends. According to the invention, the use of at least one slip fitting permits a continuous length of conduit to extend through the fitting, and by doing so, extend through the corresponding sump wall.

According to this embodiment, the tapered pipe fitting is a socket fitting with a tapered inner surface 58 for mating with the outer surface of an end of a secondary pipeline 60. The slip fitting has an inner diameter 62 that generally corresponds to the outer diameter of a primary pipeline 64 that is arranged coaxially within the secondary pipeline. The inner surface of the coupler at the slip fitting further defines an adhesive channel 66 which communicates with the outer surface of the coupler through an adhesive injection port 68. The use of the adhesive channel and adhesive injection port will be described in further detail later.

The change in diameter between the first and second ends of the coupler generally occurs at an inner step 70 on the inner surface of the coupler approximately midway between the integral flange and the second end of the flanged coupling. Between the tapered pipe fitting and the inner step, the inner surface of the coupler defines a circumferential rib 72 which will be described later. A threaded secondary pipeline test port 74 extends through the outer surface of the coupler to the inner surface of the coupler at the inner step toward the first end of the coupler.

In order to assemble the penetration fitting of this embodiment, the inside and outside surfaces of the sump immediately surrounding the aperture are prepared to receive a suitable adhesive such as by sanding. An adhesive is applied to the first flange face and the first flange face is pressed against the outer surface of the sump with the coupler extending through the aperture. Adhesive is then applied to both the second flange face, and to the outer bonding surface of the flanged coupling. The ring flange is slipped over the coupler from inside the sump and the second flange face is pressed against the inner wall of the sump with the inner bonding surface mating with the outer bonding surface of the flanged coupling.

Referring to FIG. 1B, an assembly clamp 78 is illustrated for use in holding the penetration fitting to the sump wall while the adhesive sets. The assembly clamp includes a backing plate 80 for abutting against the first end of the coupler with a threaded bolt 82 extending perpendicularly through its surface and extending through the coupler from one side of the sump wall to the other. A spider 84 includes two or more legs 86 that press against the ring flange, and a central hole through which the threaded bolt extends. By threading a nut 88 onto the threaded bolt, the backing plate and spider are pressed toward one another, in turn pressing the integral flange and the ring flange against the outer and inner walls of the sump wall while the adhesive sets. Once the adhesive has set, the clamp may be removed for use on another penetration fitting. In order to ensure a good seal, beads 90 of additional adhesive may be applied over the adhesive joints.

Though not shown, rather than using an assembly clamp, the flange rings may include bolt holes such that the flanged coupling and the flange ring can be bolted to one another. The use of bolted flanges is well known in the art. A bolted flange would not only hold the penetration fitting in place while the adhesive sets, it can also provide an added level of strength to the penetration fitting at the expense of requiring additional parts and additional preparation of the sump wall to accommodate the bolts.

Referring to FIG. 1C, once the penetration fitting has been bonded to the sump wall, the piping can be connected. First, both the primary and secondary pipe runs are cut to length and dry fitted between the various pieces of equipment. As necessary, mating surfaces of the pipelines and fittings are prepared for receiving one another such as by using sandpaper to roughen the mating surfaces. Furthermore, the portion of the primary pipe extending through the coupler is roughened at the portion of the outer surface that coincides with the adhesive channel of the coupler.

After an acceptable dry fit has been achieved, the primary pipeline segments and fittings are glued or otherwise connected to one another using known methods with the exception that the portion of the primary pipeline extending through the penetration fitting is not glued to the penetration fitting. Rather, before the penetration fitting and primary pipeline are adhered to one another, the primary piping system is pressure tested using known procedures to determine if there are any leaks. If a leak is detected, the corresponding section of pipe or fitting that is responsible for the leak is repaired or replaced.

Once the primary system has been confirmed to be pressure tight, the primary pipeline is glued to the penetration fitting. This is accomplished by applying a suitable adhesive through the adhesive injection port on the coupler such that the adhesive fills the adhesive channel, filling the void between the coupler and the primary pipeline. One method of applying the adhesive is using a syringe.

The various sections of the secondary piping system are then glued or otherwise interconnected to one another using known methods. For the connection between an end of the secondary pipeline and the tapered pipe fitting of the flanged coupling, adhesive may be brushed around the end of the secondary pipeline and the end is pressed into the tapered pipe fitting using well-known methods for joining tapered pipe segments. When joining the secondary pipeline to the tapered pipe fitting of the penetration fitting, the circumferential rib helps to prevent excess adhesive from clogging the secondary pipeline test port.

For those applications where there is a fixed length of secondary pipeline running between two pieces of equipment, for example, where a pipeline runs between two sumps, two or more pieces of secondary pipeline which together have a length less than the fixed length may be used in combination with a clamshell coupler to join the segments, resulting in a continuous secondary piping system running the fixed length. The use of such clamshell fittings is well known and allows longitudinal movement of the secondary pipeline during installation. In particular, when interconnecting the secondary pipeline between two penetration fittings, a length of secondary pipeline is adhered to the tapered fitting of each penetration fitting, and then a clamshell coupler completes the assembly by coupling the two pieces of secondary pipeline.

Once the secondary system has been fully assembled, it may be pressure tested by applying a test fluid such as compressed air into the annular space between the primary and secondary pipelines via the secondary pipeline test port. Because such tests must be performed periodically long after the installation has been completed, in an embodiment, one or more of the secondary pipeline test ports may be fitted with Schrader valves (not shown) which permit convenient connection of a compressed air source for pressure testing. A pressure gauge (not shown) can also be included at the secondary pipeline test port to assist in pressure testing. Any unused secondary pipeline test ports may be closed with plugs (not shown.)

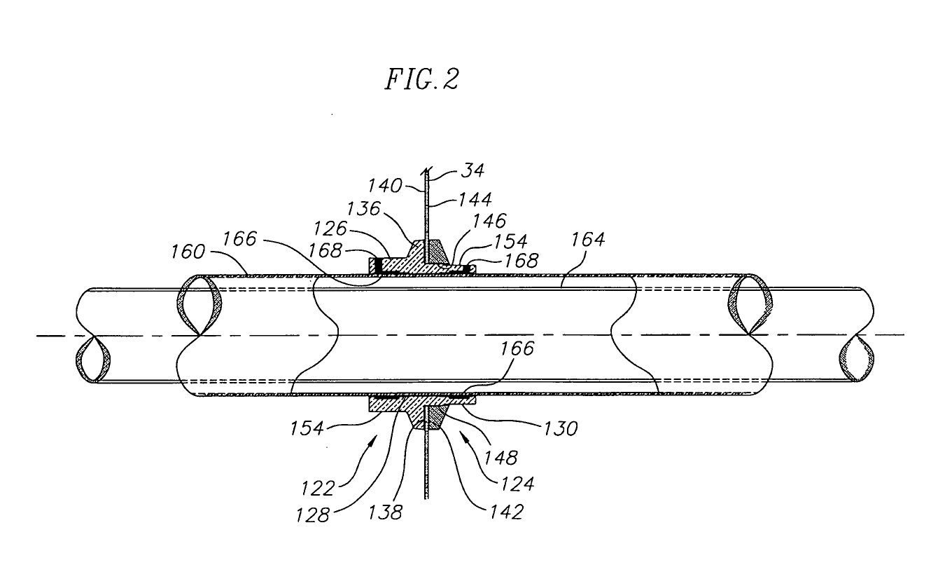

Turning to FIG. 2, another embodiment of a penetration fitting is illustrated. In this embodiment, the penetration fitting is for sealing a straight run of secondary pipeline through a sump wall 34. Similar to the previous embodiment, the penetration fitting includes a flanged coupling 122 and a mating flange ring 124. The flanged coupling includes a generally tubular coupler 126 defining inner 128 and outer 130 surfaces. The tubular coupler extends through an aperture of the sump and includes an integral flange 136 with a first flange face 138 for abutting an outer wall 140 of the sump wall. The flange ring similarly includes a second flange face 142 for abutting an inner wall 144 of the sump wall and an inner bonding surface 146 for mating with an outer bonding surface 148 on the outer surface of the flanged coupling and generally adjacent the first flange face of the flanged coupling.

According to this embodiment, the inner surface of the coupler forms a pair of slip fittings 154, each with an inner diameter that generally corresponds to the outer diameter of a secondary pipeline 160. A primary pipeline 164 is arranged coaxially within the secondary pipeline. The inner surface of the coupler further defines an adhesive channel 166 at each slip fitting. Each adhesive channel communicates with the outer surface of the coupler through an adhesive injection port 168.

The assembly of the penetration fitting of this embodiment to the sump wall can be accomplished using a method identical to that previously described. As with the previous embodiment, once a penetration fitting has been adhered to a corresponding sump wall, the primary and secondary pipelines are dry fitted. The outer surface of the portion of the secondary pipeline extending through the penetration fitting is prepared for receiving an adhesive such as by sanding. The segments and fittings of the primary pipeline are then glued or otherwise connected to one another using known methods and the primary pipeline system is pressure tested using known procedures. If no leak is detected, the segments and fittings of the secondary pipeline system are glued or otherwise connected to one another. A suitable adhesive is applied to each of the adhesive injection ports to fill the adhesive channels and form a seal between the secondary pipeline and the penetration fitting.

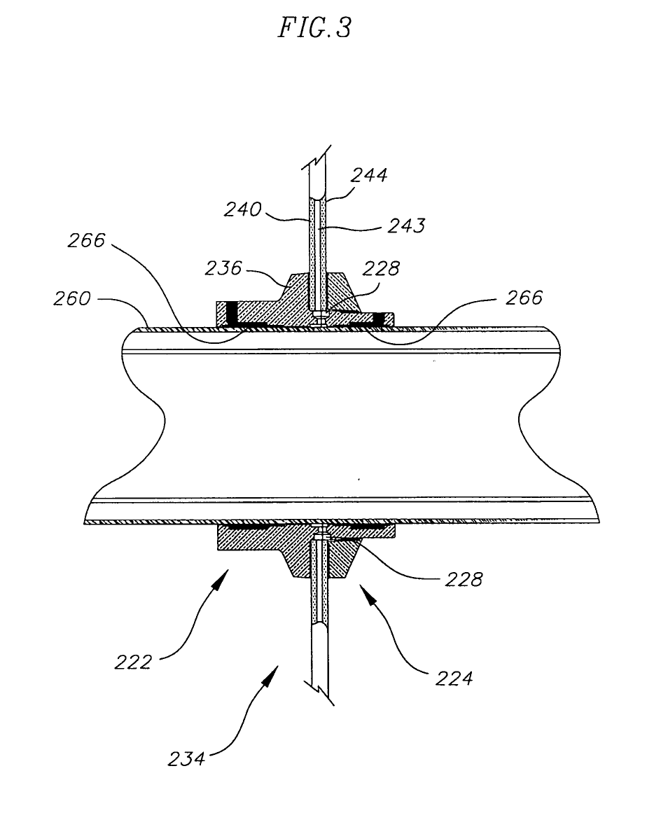

Turning to FIG. 3, a variation on the penetration fitting of FIG. 2 is illustrated. This penetration fitting is designed for sealing a straight run of secondary pipeline 260 to a double-wall sump wall 234 which includes an outer wall 240 and an inner wall 244 separated from one another and forming a sump wall interstice 243. As with the previous embodiments, the penetration fitting includes a flanged coupling 222 with an integral flange 236 and a mating flange ring 224. The fundamental difference between this embodiment and that of FIG. 2 is that the inner surface of the coupling includes one or more interstitial ports 228 extending through the coupling adjacent the integral flange such that the when the penetration fitting is assembled, the interstice of the double-wall sump wall communicates with the portion of the outer wall of the secondary pipeline between adhesive joints 266. This feature enables testing the integrity of the adhesive joints by pressure testing the sump wall interstice. If one or the other of the adhesive joints is faulty, leakage from the interstice would be detected during such a pressure test.

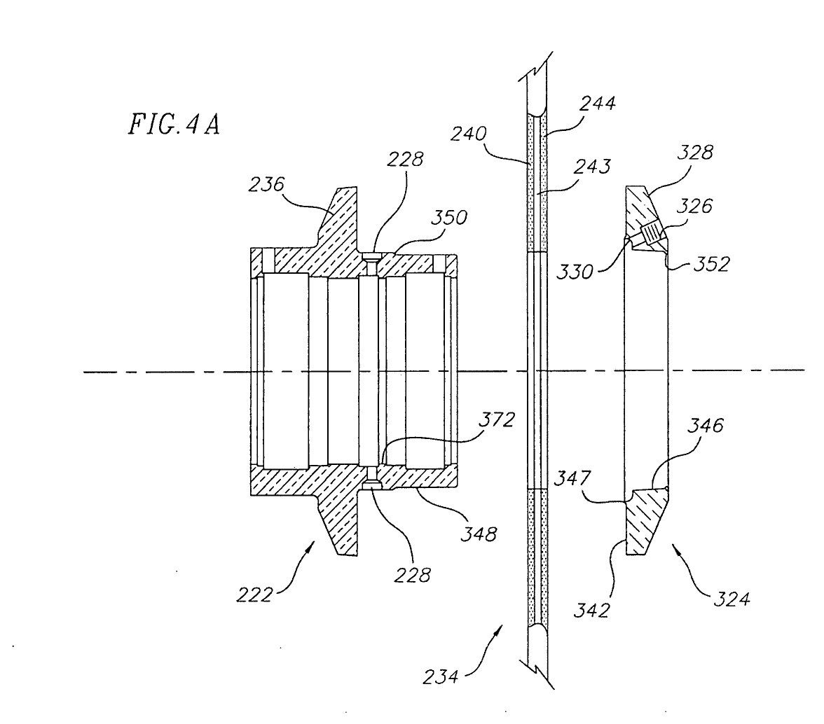

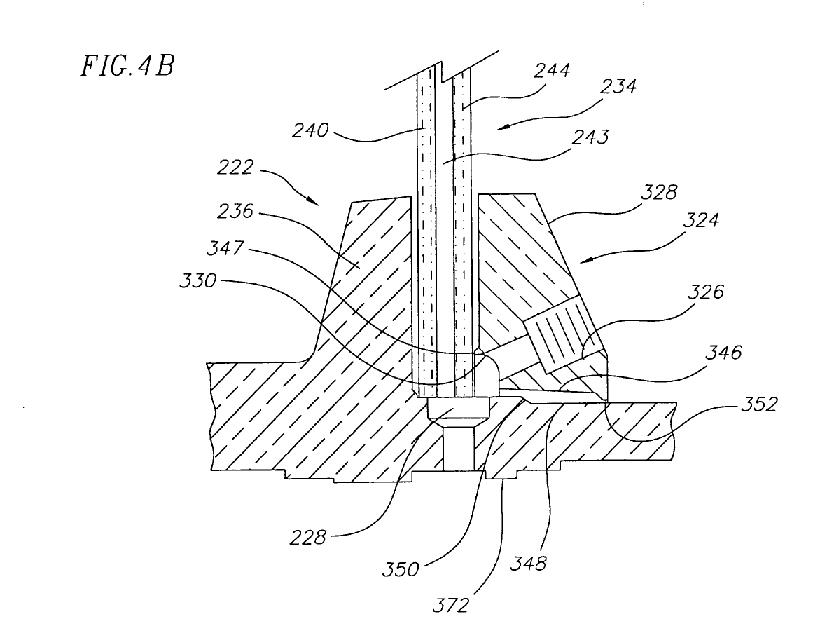

Turning now to FIGS. 4A and 4B, the penetration fitting of FIG. 3 is illustrated with a modified flange ring 324. For ease of illustration, FIG. 4B shows the penetration fitting assembled, but in a dry-fit state, that is, without showing the adhesive joints. As with the previous embodiment, a secondary pipeline (not shown) is sealed to a sump with a double-wall sump wall 234 which includes an outer wall 240 and an inner wall 244 separated from one another to form an interstice 243. The penetration fitting includes a flanged coupling 222 with an integral flange 236 and one or more interstitial ports 228.

In this embodiment, the flange ring includes a threaded interstice test port 326 extending from an outer surface 328 of the flange ring to an inner circumferential channel 330 located at the intersection of the flange face 342 and the inner bonding surface 346 of the ring flange. The inclusion of the circumferential channel allows the interstice test port to communicate with the interstitial channels which in turn communicate with the interstice of the double-wall sump wall.

FIGS. 4A and 4B further illustrate certain specific features which may be provided on the ring flange and the outer bonding surface of the flanged coupling. In particular, the flange face 342 of the ring flange includes a lip 347 at the inner circumferential channel 330 which helps to prevent excess adhesive from filling the circumferential channel or the interstitial ports 228 when the adhesive is applied to adhere the flange face to the sump wall during assembly. Similarly, the outer bonding surface 348 of the flanged coupler includes a circumferential shoulder 350 which similarly inhibits excess adhesive from blocking the circumferential channel or the interstitial channels when the adhesive is applied to the inner and outer bonding surfaces. The inner bonding surface 346 of the flange ring includes an outer wiper ring 352 which helps to keep the adhesive from seeping out of the inner and outer bonding surfaces during assembly. Similarly, the inner surface of the coupling includes an inner circumferential rib 372 between the adhesive channel and the interstitial ports to inhibit adhesive used in gluing the penetration fitting to the secondary pipeline from blocking the interstitial ports.

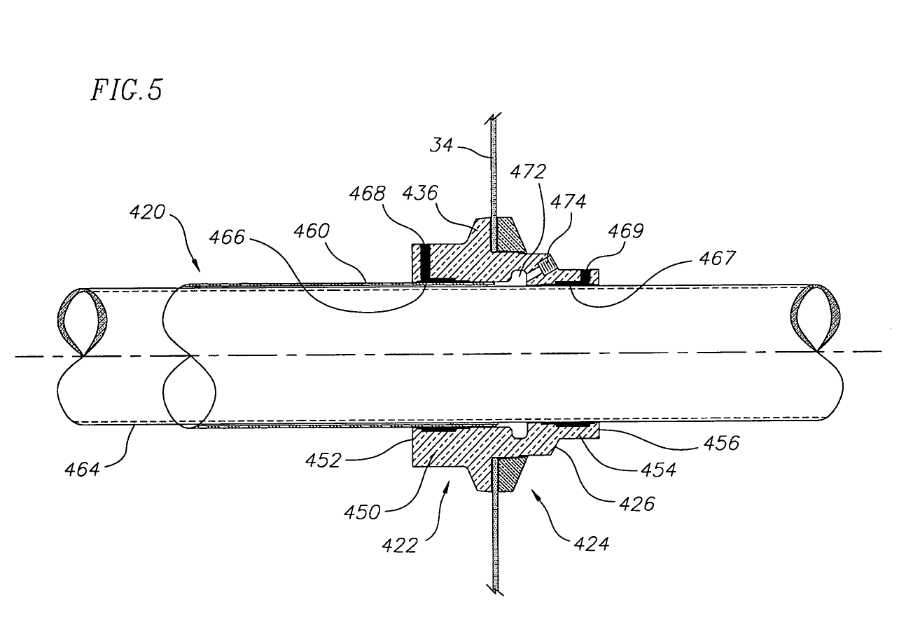

Turning now to FIG. 5, yet another embodiment of the penetration fitting of the present invention is illustrated. This penetration fitting is for sealing a prefabricated coaxial pipeline 420 to a sump wall 34. Such prefabricated coaxial pipelines are well known and generally include a secondary pipeline 460 integrally fabricated over an internal primary pipeline 464. Manufacturers of coaxial fiberglass pipelines include Ameron International.

The penetration fitting of this embodiment is similar to that of FIGS. 1A to 1C, and includes a flanged coupling 422 and a mating flange ring 424. The flanged coupling includes a generally tubular coupler 426 with an integral flange 436. The coupler of this embodiment is also a reducing coupler with a first slip fitting 450 at a first end 452 and a second slip fitting 454 at a second end 456. The inner surfaces of the coupler at the first and second slip fittings further define first and second adhesive channels 466 and 467 which communicate with the outer surface of the coupler through first and second adhesive injection ports 468 and 469. During assembly, adhesive applied through the first adhesive injection port fills the first adhesive channel surrounding the secondary pipeline while adhesive applied through the second adhesive injection port fills the second adhesive channel surrounding the primary pipeline. Like previous embodiments, the flange ring includes a secondary pipeline test port 474 communicating with the annular space between the primary and secondary pipelines. However, for this embodiment, because the primary and secondary pipelines tend to be fairly closely spaced for such prefabricated coaxial pipelines, an inner circumferential channel 472 is provided to prevent excess adhesive from clogging the secondary pipeline test port.

Assembly of this penetration fitting to the sump wall may be accomplished using methods as described above. Once the penetration fitting has been adhered to the sump wall, for the portion of the coaxial pipeline extending into the sump, a portion of the secondary pipeline is stripped from the coaxial pipeline to expose a section of the primary pipeline. The portions of the primary and secondary pipelines corresponding to the respective sleeve fittings are prepared for assembly such as by sanding their outer surfaces.

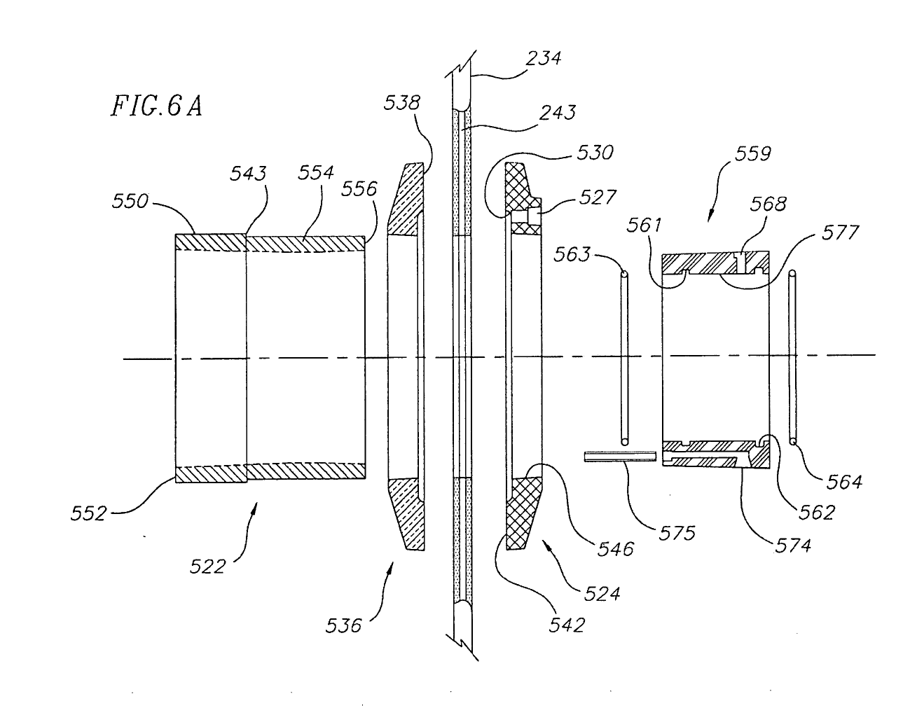

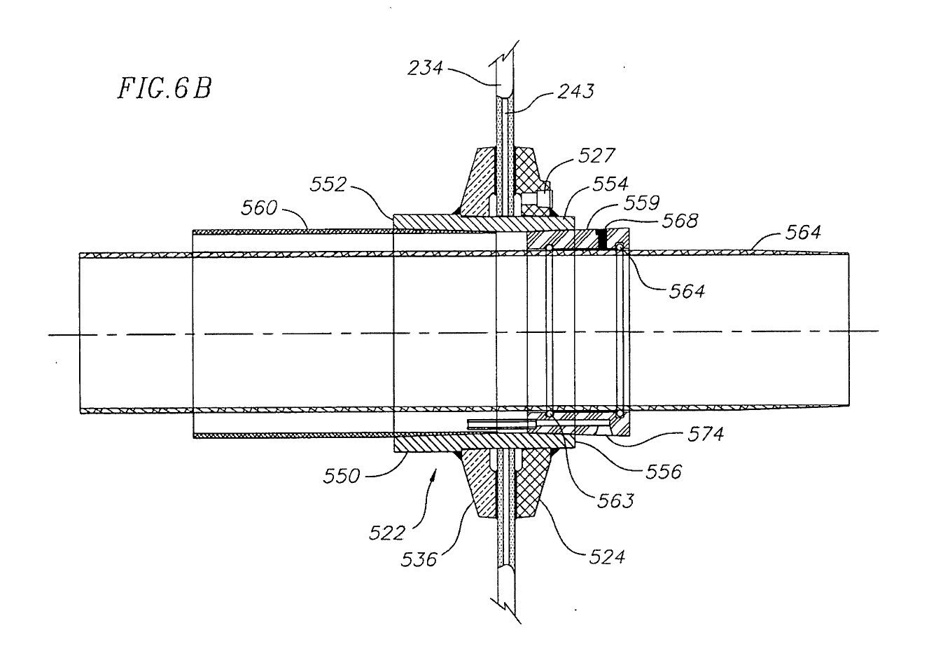

Turning to FIGS. 6A and 6B, still another embodiment of the present invention is illustrated for use with a double-wall sump wall 234 having an interstice 243. According to this embodiment, the penetration fitting includes a coupling 522 with first and second flange rings 536 and 524. Rather than being integral, the first flange ring is provided as a separate piece which fits over the coupling and abuts a shoulder 543 of the coupling. As with previous embodiments, the flange rings include first and second flange faces 538 and 542 for abutting opposing sides of the sump wall.

The second flange ring further includes an optional interstice test port 527 which communicates with an inner circumferential channel 530 located at the intersection of the second flange face and an inner bonding surface 546 of the ring flange. The inclusion of the circumferential channel allows the interstice test port to communicate with the interstice 243 of the double-wall sump for reasons as described above.

The coupling further includes a tapered pipe fitting 550 at a first end 552 for mating with the outer surface of an end of a secondary pipeline 560. The coupling further includes a tapered bushing fitting 554 at a second end 556.

The penetration fitting of this embodiment further includes a reducer bushing 559 with an outer surface that mates with the tapered bushing fitting of the coupling, and an inner surface forming a slip fitting 577 with the primary pipeline 564. The inside surface of the bushing reducer includes a pair of spaced grooves 561 and 562 that receive corresponding o-rings 563 and 564. It should be noted that the o-rings do not necessarily form a seal with the primary pipeline, but rather, are intended to generally create an adhesive channel for keeping the generally viscous adhesive in place during assembly, the adhesive being applied through an optional adhesive injection port 568.

The bushing reducer further includes an optional secondary pipeline test port 574 that allows communication with the annular space between the primary and secondary pipelines after the penetration fitting is assembled. An optional extension tube 575 helps keep adhesive from blocking the secondary pipeline test port.

In assembling the penetration fitting of this embodiment, adhesive is applied to the inner bonding surface and the first flange ring is adhered to the coupling. This step may be performed during the manufacture of the coupling, or could be done by the installer before beginning work at the site. Alternatively, it may be done in the field. The coupling with the first flange ring installed is passed through the aperture of the sump wall and the first flange face is pressed against the sump wall. Adhesive is applied to the outer bonding surface of the coupling and the face of the second flange and the second flange is placed over the coupling and the second flange face is pressed against the sump wall. The penetration fitting may be held in place using an assembly clamp as described above.

As in previous embodiments, the primary and secondary pipelines are then cut to length, the joints are prepared for receiving adhesive, and the piping segments are dry-fit to one another. Then the primary pipeline is assembled without being adhered to the reducer bushing, and is pressure tested. Once the primary pipeline has been satisfactorily pressure tested, the secondary pipeline is assembled including the connection to the penetration fitting.

Once the secondary pipeline has been assembled, the reducer bushing is slid along the primary pipeline away from the penetration fitting, adhesive is applied to its outer surface and the reducer bushing is slid back into place within the coupling. The primary pipeline is then adhered to the coupling by applying adhesive through the adhesive injection port. Alternatively, if no adhesive injection port is provided, adhesive is applied over the primary pipeline at the joint with the reducer bushing at the same time that adhesive is applied to the outer surface of the reducer bushing and the bushing is simultaneously adhered to the coupling and the primary pipeline. Using this alternative procedure, it may be useful to omit the o-ring 563 closest the flange so that it does not wipe the adhesive away from the intended adhesive joint. However, for this embodiment, the o-ring 564 distant the flange is useful in wiping adhesive into place as the reducer bushing is slid into place.

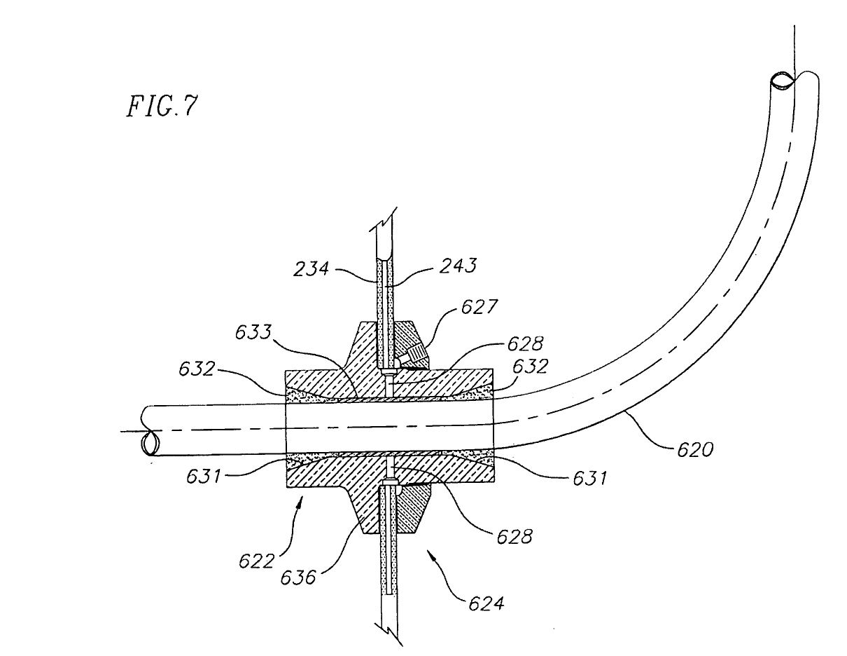

Turning to FIG. 7, yet another embodiment of a penetration fitting is illustrated, this penetration fitting for sealing a curved conduit 620 such as an electrical conduit to a double-wall sump wall 234 having an interstice 243. The penetration fitting includes a flanged coupling 622 with an integral flange 636 and a mating flange ring 624. One or more interstitial ports 628 are provided as described above, as is an optional interstice test port 627.

The outer geometry of this penetration fitting is also similar to those previously described, and will not be described in detail here. One important difference in this penetration fitting is that the inner surface of the coupling is of a diameter somewhat larger than the diameter of the curved conduit, and further includes a bell-shaped opening 631 at each end. The larger diameter inside the coupling along with the bell-shaped openings allow a curved conduit to more easily be slipped into place without placing undue stress on the penetration fitting. In the past, prior art rigid penetration fittings have been broken during installation of electrical conduit as the conduit is snaked through the penetration fitting and into position.

For this embodiment, a gap filling adhesive 632 is used to fill the gap formed between the curved conduit and the bell-shaped openings inside of the coupling. In one embodiment, an elastomeric adhesive is used to permit some additional flexibility after installation. While not shown, adhesive injection ports may be used to assist in the application of the adhesive.

Another option for such a penetration fitting is the inclusion of a foam spacer 633 located in the inside center of the penetration fitting. The use of the spacer prevents adhesive from blocking the interstitial ports with adhesive during assembly. In one embodiment, the foam is an open cell foam that inhibits flow of the viscous adhesive while permitting flow of less viscous fluids such as compressed air, or other fluids used for testing the integrity of the interstice. In another embodiment, a temporary foam spacer is used to temporarily prevent adhesive from blocking the interstitial ports during assembly. Such a temporary foam spacer may be made of a material that may be dissolved with a suitable solvent after assembly.

The embodiments of the invention described above have generally been directed to fiberglass fittings. Such fittings are generally made of compression molded fiberglass and are useful for connection to fiberglass sumps, and for use with systems using fiberglass pipe because the same adhesives commonly used to connect such fiberglass piping may be used in bonding the penetration fitting to the sump wall. However, in some instances, other materials may be desired. Therefore, the fittings of the present invention are not limited to fiberglass, but may be made of other materials, and in particular, may be made of polymers. Suitable polymers include polyolefins, and in particular, polyethylene and polyvinylidene fluoride.

When using materials other than fiberglass, it is important that compatible glues or adhesives be used, or that other compatible connection techniques be employed. For example, if a polymeric material such as polyolefin is used, the connections may be made using heat welding or solvent welding procedures rather than using externally applied adhesives. Furthermore, while the tolerances of the joints in the embodiments shown are generally illustrated for use with a gap-filling adhesive such as is commonly used with fiberglass fittings, tighter tolerances may be desired for fittings using solvent or heat welding assembly techniques.

It is also generally known that adhering dissimilar materials may be difficult in a field installation. For example, adhering fiberglass to polyethylene while maintaining a good, pressure-tight seal has proven difficult in the field. Therefore, still further embodiments of the present invention are contemplated as set forth below.

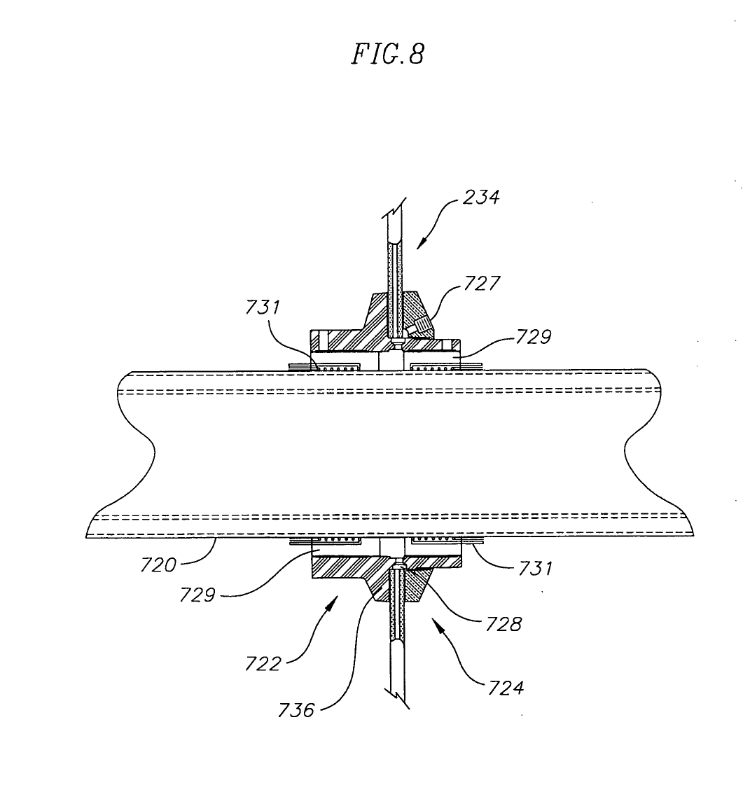

Turning to FIG. 8, a penetration fitting for an installation combining fiberglass sumps and polyethylene pipes is illustrated. A fiberglass double-wall sump wall 234 is provided as described above. The penetration fitting is generally of fiberglass construction with a flanged coupling 722 with an integral flange 736 and a mating flange ring 724. One or more interstitial ports 728 are provided as described above, as is an optional interstice test port 727. However, an important difference in this fitting is the inclusion of polyethylene sleeves 729 that are bonded to the fiberglass portions of the fitting. It is noted that making such bonds in the factory is generally simpler than making such bonds in the field as the proper conditions for bonding can more easily be controlled in a factory setting. Examples of such bonding techniques are found in U.S. Pat. No. 5,900,321 which is incorporated by reference. The polyethylene sleeves further include optional electrical elements 731 which permit the fitting to be welded to the pipeline 720 upon application of an electrical current to the electrical elements.

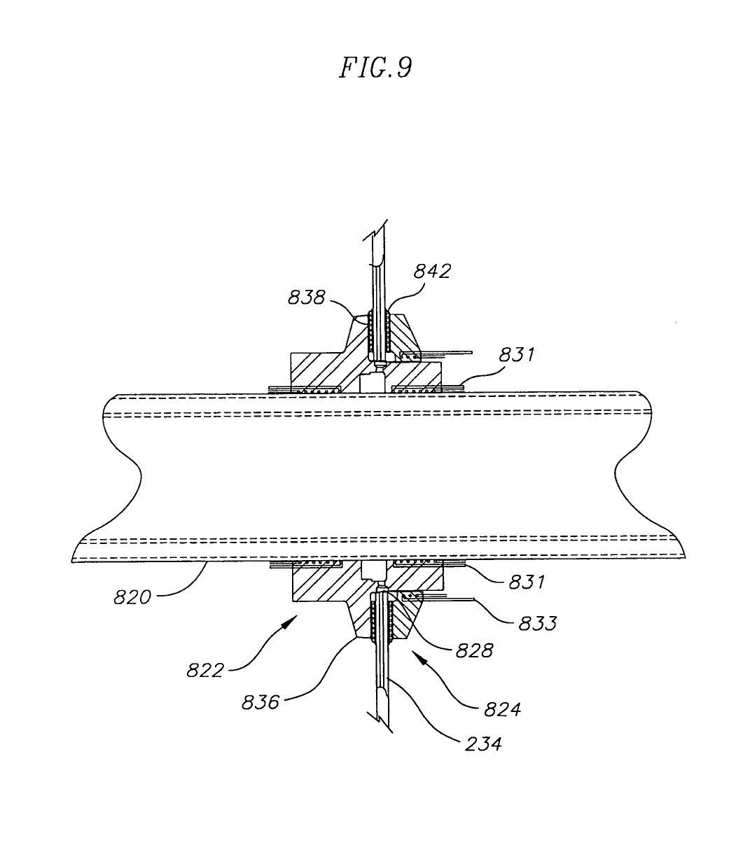

Still another embodiment for use in a system with a fiberglass sump and polyethylene piping is illustrated in FIG. 9. A fiberglass double-wall sump wall 234 is provided as described above. The penetration fitting of this embodiment is generally of polyethylene with a flanged coupling 822 with an integral flange 836 and a mating flange ring 824. One or more interstitial ports 828 are provided as described above. As with the previous embodiment, the fitting includes optional electrical elements 831 which permit the fitting to be welded to the pipeline 820 using electrical current. However, for this fitting, fiberglass flange faces 838 and 842 are bonded to the polyethylene flanges in the factory. Of course, the use of fiberglass faces permits bonding to a fiberglass sump wall using adhesives commonly used for bonding fiberglass fittings to one another. A further feature of this embodiment is the inclusion of another optional electrical element 833 on the flange ring to permit the flange ring to be welded to the flanged coupling by applying electrical current.

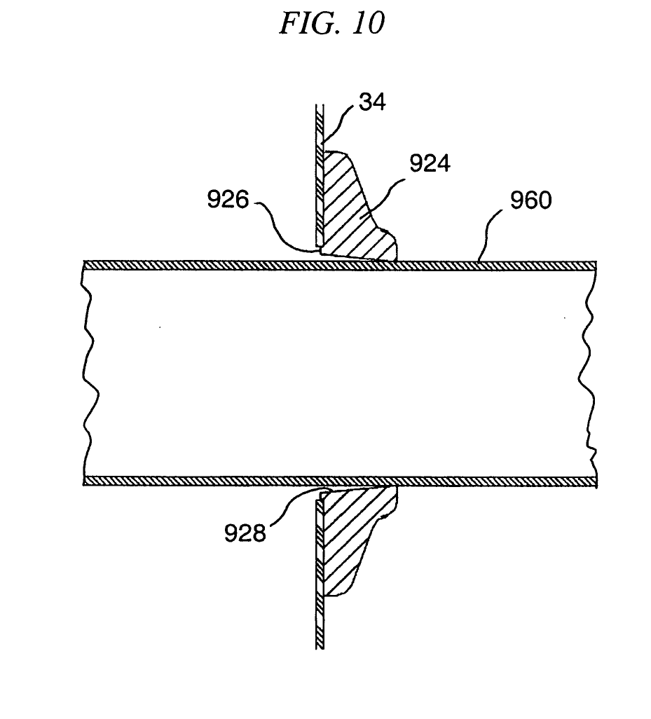

Turning to FIG. 10, still another embodiment of the invention is illustrated. According to this embodiment, a penetration fitting comprises a flange ring 924 which seals a pipeline 960 to a sump wall 34. A centering lip 926 on the flange ring helps to center the flange ring with respect to the sump wall. As with previous embodiments, a face of the flange ring is adhered to the sump wall. A tapered interior surface 928 of the flange ring acts as a slip fitting to seal the flange ring to the pipeline. The use of a tapered interior surface simplifies installation by preventing the pipeline from binding within the flange ring, and further creates an adhesive channel for ensuring a good seal. For this embodiment, an optional second flange ring (not shown) identical to the flange ring shown may be adhered to the pipeline and the opposite side of the sump wall. In such an embodiment, the centering lips of the opposing flange rings may be sized such that the opposing flange rings are adhered to one another at installation. Alternatively, they may be sized such that they are spaced from one another after installation. When installing the penetration fitting of this embodiment, the flange ring is loosely fit over the pipeline and once the various connections for the pipeline have been made, the flange ring is adhered to both the sump wall and the pipeline to form a seal.

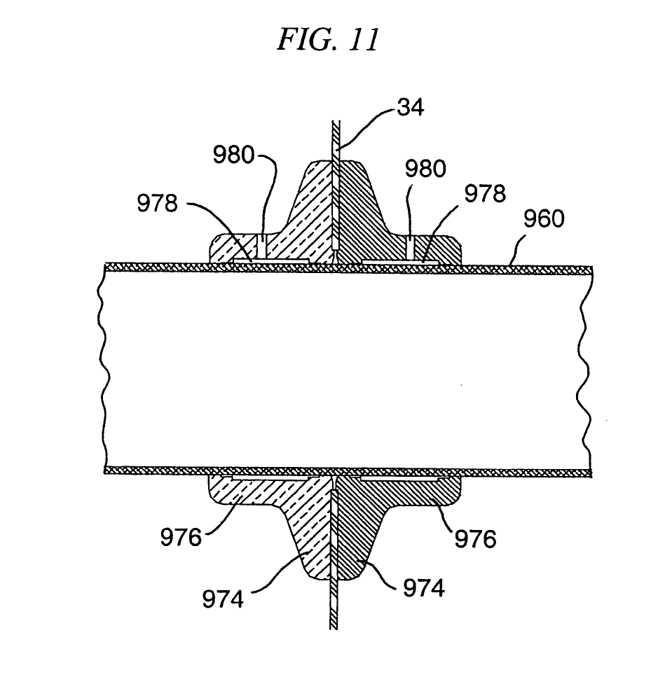

Referring to FIG. 11, still another embodiment of a penetration fitting is illustrated. This embodiment is similar to that of FIG. 10 in that the penetration fitting comprises a pair of identical flange rings 974 which seal a pipeline 960 to a sump wall 34. For this embodiment the flange rings each include an integral sleeve 976 which serves as a slip fitting. Each integral sleeve defines an adhesive channel 978 and an adhesive injection port 980 through which adhesive can be applied to seal the flange ring to the pipeline as described in previous embodiments. It is noted that while two flange rings are illustrated, one may be omitted such that a single flange ring is used.

While certain embodiments of the invention have been described, each having certain useful features, many modifications and different combinations would be apparent to one of ordinary skill in the art upon reviewing the present specification. Therefore, the invention is not to be limited to the specific embodiments illustrated, but rather, is limited only by the spirit and scope of the following claims.

What is claimed is:

1. A penetration fitting adapted to form a seal between a pipeline and a sump wall at an aperture of the sump wall, the penetration fitting comprising:
a flanged coupling comprising: a coupler with first and second fitting ends, the second fitting end adapted to extend through the aperture; and a first flange extending around a portion of the coupler and adapted to abut a first side of the sump wall around the aperture wherein at least one of the first and second fitting ends is a slip fitting for sealing the coupler to the pipeline; and
a ring flange adapted to be adhered to an outer circumferential portion of the coupler and abut a second side of the sump wall around the aperture.

2. The penetration fitting of claim 1 wherein the first flange is integral to the coupler.

3. The penetration fitting of claim 1 wherein the slip fitting includes an interior adhesive channel and an adhesive injection port.

4. The penetration fitting of claim 1 where the pipeline is a coaxial pipeline comprising a primary pipeline arranged coaxially within a secondary pipeline and defining an annular space between the primary and secondary pipelines, wherein the first fitting end is adapted to mate with the secondary pipeline and the second fitting end is the slip fitting, wherein the slip fitting is adapted to mate with the primary pipeline.

5. The penetration fitting of claim 4 further comprising a secondary test port for external communication with the annular space.

6. The penetration fitting of claim 4 wherein the first fitting end is a tapered fitting.

7. The penetration fitting of claim 4 further comprising a reducer bushing adapted to be received by the second fitting end, the reducer bushing defining an interior surface adapted to mate with the primary pipeline.

8. The penetration fitting of claim 1 wherein both the first fitting end and the second fitting end comprises slip fittings.

9. The penetration fitting of claim 8 wherein each of the first and second slip fittings further comprises an adhesive channel and an adhesive injection port.

10. The penetration fitting of claim 8 wherein each of the first slip fitting and the second slip fitting is adapted to mate with a secondary pipeline.

11. The penetration fitting of claim 1 wherein the sump wall is a double-wall sump wall defining a sump wall interstice, the penetration fitting further comprising at least one interstitial port permitting communication between the sump wall interstice and an outer wall of the pipeline.

12. The penetration fitting of claim 11 further comprising an interstice test port in communication with the at least one interstitial port.

13. The penetration fitting of claim 1 wherein each of the first and second fitting ends defines a bell-shaped opening.

14. The penetration fitting of claim 1 wherein the penetration fitting is generally made of a first material and further includes at least one sleeve insert made of a second material different from the first material, the at least one sleeve insert defining at least one of the first and second fitting ends.

15. The penetration fitting of claim 14 wherein the first material is fiberglass and the second material is polyethylene.

16. The penetration fitting of claim 1 wherein the penetration fitting is generally made of a first material and further includes first and second flange inserts made of a second material different from the first material.

17. The penetration fitting of claim 16 wherein the first material is polyethylene and the second material is fiberglass.

18. A penetration fitting adapted to form a seal between a pipeline and a sump wall at an aperture of the sump wall, the penetration fitting comprising:
a flanged coupling comprising: a coupler with first and second fitting ends, the second fitting end adapted to extend through the aperture; and a first flange extending around a portion of the coupler and adapted to abut a first side of the sump wall around the aperture, wherein at least one of the first and second fitting ends is a slip fitting for sealing the coupler to the pipeline;
a ring flange adapted to be adhered to an outer circumferential portion of the coupler and abut a second side of the sump wall around the aperture; and
at least one interstitial port permitting communication between the sump wall interstice and an outer wall of the pipeline.

19. The penetration fitting of claim 18 wherein the pipeline is a coaxial pipeline comprising a primary pipeline arranged coaxially within a secondary pipeline and defining an annular space between the primary and secondary pipelines, wherein the first fitting end is adapted to mate with the secondary pipeline and the second fitting end is the slip fitting, wherein the slip fitting is adapted to mate with the primary pipeline.

20. The penetration fitting of claim 19 wherein the slip fitting includes an interior adhesive channel and an adhesive injection port.

21. The penetration fitting of claim 19 further comprising a secondary test port permitting external communication with the annular space, and an interstice test port permitting external communication with the sump wall interstice.

22. The penetration fitting of claim 18 wherein each of the first slip fitting and second slip fitting is adapted to mate with the secondary pipeline.

23. The penetration fitting of claim 18 wherein the first slip fitting is adapted to mate with the secondary pipeline and the second slip fitting is adapted to mate with the primary pipeline.

24. A penetration fitting adapted to form a seal between an aperture of a double-wall sump wall defining a sump wall interstice and at least one of a primary pipeline and a secondary pipeline, wherein the primary pipeline is arranged coaxially within the secondary pipeline to define an annular space between the primary and secondary pipelines, the penetration fitting comprising:
a flanged coupling comprising: a coupler with a first fitting end adapted to mate with the secondary pipeline and a second fitting end adapted to extend through the aperture and mate with the primary pipeline; and a first flange extending around a portion of the coupler and adapted to abut a first side of the sump wall around the aperture;
a ring flange adapted to be adhered to an outer circumferential portion of the coupler and abut a second side of the sump wall around the aperture; and
at least one interstitial port permitting communication between the sump wall interstice and an outer wall of the second pipeline.
